(19) United States
(12) Patent Application Publication
(10) Pub. No.: US 2009/0039019 A1
(43) Pub. Date: Feb. 12, 2009

(54) POROUS MEMBRANES CONTAINING EXCHANGE RESINS

(75) Inventor: Ven Anantha Raman, Salem, NH (US)

Correspondence Address: BANNER & WITCOFF, LTD.;ATTORNEYS FOR CLIENT NO. 006357, 28 STATE STREET 28TH FLOOR, BOSTON, MA, 02109, US

(73) Assignee: Entegris, Inc., Chaska, MN (US)

(21) Appl. No.: 12/029,672

(22) Filed: Feb. 12, 2008

Related U.S. Application Data
(63) Continuation of application No. PCT/US2006/032129, filed on Aug. 17, 2006.
(60) Provisional application No. 60/711,531, filed on Aug. 26, 2005.

(51) Int. Cl. B01J 47/12; B01J 47/04

(52) U.S. Cl. 210/638; 210/490; 210/321.6; 210/504

(57) ABSTRACT

Articles that include two or more exchange resins in one or more microporous membranes, where the membranes remove oppositely charged impurities from a fluid in contact with the membranes, are disclosed. Methods for using such devices to remove charged impurities from fluid in contact with the membrane are provided.

### CROSS-REFERENCE TO RELATED APPLICATIONS

This application is a continuation of PCT Application No. PCT/U.S.2006/32129 filed 17 Aug. 2006 and published in the English language as PCT Publication No. WO 2007/024619 on 1 Mar. 2007. The PCT Application claims priority from commonly owned U.S. Provisional Application Ser. No. 60/711,531, filed 26 Aug. 2005. The disclosures of each of these documents are hereby incorporated herein by reference.

### BACKGROUND OF THE INVENTION

Impurities in process fluids used in coatings, substrate cleaning, or for preparing reagents and pharmaceuticals can cause defects and product loss. For example, metal ions in fluids such as water or photoresist can result in unwanted doping of semiconductor materials during cleaning or substrate coating processes. The presence of impurities like tertiary amines can degrade pharmaceutical compositions. Impurities formed as the result of degradation of various components in the manufacture of pharmaceutical compositions, coating materials, or cleaning solutions may also need to be removed before their final use.

A process of making microporous ion exchange particle filled UPE membranes is described in U.S. Pat. 5,531,899. Purification of process chemicals using media such as ion exchange resin beads and radiation grafted microporous and non-woven polyethylene membranes with cation exchange groups are described in the following patents; JP 2003-251120A, JP 2003-251118A, U.S. Pat. No. 5,350,714, U.S. Pat. No. 5,550,127, and U.S. Pat. No. 5,962,183. Mixed bed ion exchange columns used for purification of water typically requires large volumes of resin material and produce high-pressure drop under high fluid flux. They also have low surface area and are susceptible to channeling and fluidization of the bed. These effects can result in poor kinetic performance and less effective utilization of the available resin capacity. Surface functionalized membranes have been used for water purification, however at temperatures near 80° C. these materials may be susceptible to cracking and can have limited performance for ion removal. Fluids like water can be used for cleaning substrates, dissolving reagents, and mixing with other chemicals for treating substrates. During heating and transport to the point of use, the water can pick up trace impurities that may need to be removed prior to its use. Cost effective removal of cationic and anionic impurities from fluids such as organic solvents, hot water, and aqueous solutions like base cleaning solutions (SC1, which is a mixture of ammonium hydroxide, hydrogen peroxide, and water) would provide improved manufacturing processes and reduce losses and defects caused by these impurities.

Cation exchange porous membranes and a sieving microporous filter may be used to remove cations and particles from fluids like water and SC1, however anionic species formed in these fluids may not be removed by this configuration. Further, this configuration of cation exchange porous membranes and a sieving microporous filter can result in a high pressure drop.

Surface modified cation exchange membranes for water and hot water purification are incapable of removing anions and anion complexes, thus causing inefficient purification. These types of membrane can also be less stable due to the long term effect of the heat and fluid on the surface modification or functionalization. The combination of heat and fluid can lead to breakdown of the base membrane and loss of functional groups with subsequent leakage of contaminants from the membrane. Thin, surface functionalized microporous polymeric membranes may be highly susceptible to embrittlement especially when used at temperature of about 80° C. or higher in water over prolonged periods of operation.

Electrodeionization membranes are ion permeable but do not allow fluids to flow through them.

### SUMMARY OF THE INVENTION

The present invention is directed to articles that include two or more exchange resins in one or more microporous membranes, where the membranes remove oppositely charged impurities from a fluid in contact with the membranes. The present invention is also directed to methods for using such devices to remove charged impurities from fluid in contact with the membrane.

Preferred embodiments of the present invention include articles that utilize one or more types of exchange resin in one or more porous membranes. The articles can for example utilize a mixture of exchange resins that can include but is not limited to one or more cation exchange resins and one or more anion exchange resins incorporated into one or more porous membranes. The article may include separate layers of porous membrane, each layer separately including a mixture of exchange resin, like an anion or chelating exchange resin, distributed in each of the porous membranes. The exchange resin containing porous membrane can be used to remove anionic, cationic, amphoteric or any combination of these charged impurities from a fluid. The impurities can be charged colloids, charged complexes, charged polymer, charged oligomers, charged particulates or any combination of these in the fluid. In some embodiments the impurities can be colloids, complexes, polymer, oligomer, particulates or any combination of these in the fluid that can be exchanged or linked with the functional groups of the resin in the porous membrane. The mixture of two or more exchange resins in one or more porous membranes can include a mixture of exchange resin in the porous membrane that removes charged impurities that can comprise oxide, hydroxide, oxyhydroxide, carboxylate, ammonium, or any combination of these groups or other similar groups on the surfaces of the impurities. The cast porous membrane media including the mixture of resins is thermally stable and has high capacity for the retained impurities.

Preferred embodiments of the present invention also include articles that can utilize layers of exchange resin in one or more porous membranes. The articles can utilize a layer of cation exchange resin and a layer of anion exchange resin in one or more porous membranes. The article may include separate layers of porous membrane, each layer separately including an exchange resin, like an anion or cation exchange resin, distributed in each of the porous membranes. The exchange resin containing porous membrane can be used to remove anionic, cationic, amphoteric or any combination of these charged impurities from a fluid. The impurities can be charged colloids, charged complexes, charged polymer, charged oligomers, charged particulates or any combination of these in the fluid. In some embodiments the impurities can be colloids, complexes, polymer, oligomer, particulates or any combination of these in the fluid that can be exchanged or linked with the functional groups of the resin in the porous membrane. The layers of exchange resin in one or more porous membranes can include an exchange resin in the porous membrane that removes charged impurities that can comprise oxide, hydroxide, oxyhydroxide, carboxylate, ammonium, or any combination of these groups or other similar groups on the surfaces of the impurities. The cast porous membrane media including the resin is thermally stable and has high capacity for the retained impurities.

Preferred embodiments of the invention include articles that comprise two or more porous membranes where the membranes each can include a different resin that removes material of signed charge from a fluid in contact with the porous membranes. The material of different signed charge removed by the resin containing porous membrane can include charged ions, charged colloids, charged particles, or combinations of these in the fluid in contact with the membranes. The porous membrane, which can optionally be a microporous membrane, can further remove particles from the fluid by sieving filtration. Articles including layers of exchange resin in one or more porous membranes can be characterized in that they can remove ionic impurities from a feed of liquid and provide treated liquid having less than 10 ppb (v/v) of the ionic impurities in the fluid at a temperature of about 80° C. or less. In some embodiments, the one or more layers of exchange resin containing porous membrane can be characterized by removing ionic impurities from a feed of liquid water having anion and cation impurities, and provide a treated fluid having less than about 10 ppb (v/v), of anion and cation impurities in the water at a flow rate of about 10,000 to about 15,200 cm³min⁻¹ for a specified or fixed area and pressure drop for each membrane at a temperature of about 80° C. or less. In some embodiments, the one or more layers of exchange resin containing porous membrane can be characterized by providing water containing less than about 10 ppb (v/v), of iron, aluminum, copper, calcium or any combination of these impurities in the fluid at a flow rate of 10,000 to about 15,200 cm³min⁻¹ for a specified or fixed area and pressure drop for each membrane at a temperature of about 80° C. or less.

The one or more porous membranes comprising exchange resin may be fixtured to supports or to a housing, and can include but is not limited to resin containing membranes in a core and cage with optional pleating of the membrane, stacked disks of the one or more resin containing membranes, or devices where the membranes are potted exchange resin containing hollow fibers. The resin containing porous membranes may be configured in a spiral roll or on one or more supports for tangential flow filtration. Where two or more membranes are used, they may be pleated together, they can be configured together in a disc, or can be fixtured in separate housings fluidly connected by conduits. The housing may further include a third porous membrane, a flow resistance membrane or device (valve or restrictor), or other flow distributing structure (baffles) to increase the residence time of the fluid in the one or more resin containing porous membranes. The housing can further include one or more ports or fittings that provide an inlet for a flow of a fluid to the membranes and one or more ports or fittings that provide an outlet for removing fluid from the housing treated by the resin containing membranes. The housing or housings that include the resin impregnated porous membranes can be included as part of an apparatus for treating substrates or compositions with fluid treated to remove charged impurities with the membranes.

One embodiment of the invention is a process for treating a fluid that includes passing the fluid through a mixture or layers of exchange resin in one or more porous membranes to produce a fluid having less than 10 ppb (v/v), per milliliter of charged impurities in the fluid. In some embodiments, the charged impurities may include those comprising iron, aluminum, calcium, copper, or any combination of these metals. In some embodiments, the charged impurities may include those anions such as but not limited to chloride, acetate, formate, or other anions. Optionally, the filtrate treated by the layers of exchange resin in one or more porous membranes has fewer particles than the feed fluid, the particles removed by sieving filtration.

One embodiment of the invention is a method for purifying a fluid that can include the step of flowing the fluid through one or more porous membranes that provide at least two types of different exchange resin. Each resin removes material of different signed charge from the fluid. The resin in the porous membrane can include one or more ion exchange resins. The method can further include flowing the fluid through a third porous membrane. The method can be used to produce fluid having less than 10 ppb (v/v), per milliliter of ionic impurities at a temperature of about 80° C. or less. In some embodiments, the method can remove ionic impurities, such as but not limited to metal ions and complexes, organic ions and complexes like ammonium, carboxylate, phosphate, nitrite, formate, acetate, chloride, and other ions, from a feed of liquid and provides a treated fluid having less than about 10 ppb (v/v) of anion and cation impurities in the fluid. In some embodiments the impurities are removed to less than about 10 ppb at a flow rate of about 10,000 to about 15,200 cm³min⁻¹ for a specified or fixed area and pressure drop for each membrane at a temperature of about 80° C. or less. In some embodiments, the method provides water containing less than about 10 ppb (v/v), of iron, aluminum, copper, calcium or any combination of these impurities in the fluid at a flow rate of about 10,000 to about 15,200 cm³min⁻¹for a specified or fixed area and pressure drop for each membrane at a temperature of about 80° C. or less. Optionally, the fluid treated by the layers of exchange resin in one or more porous membranes has fewer particles than the feed fluid inlet to the membranes, the particles removed by sieving filtration.

Advantageously, the layers of exchange resin in one or more porous membranes used in embodiments of the invention can provide: faster kinetics at high fluid flow rate (or flux) for impurity material removal and a lower pressure drop than a microporous membrane used to remove impurities or an ion exchange column used to remove impurities. Embodiments of the invention can also provide a small hold up volume and lower pressure drop compared to conventional ion exchange packed bed column. Embodiments of the present invention can provide a smaller footprint, lower pressure drop, and use less material than ion exchange columns which typically use large quantity of materials and can produce high-pressure drop under high fluid flux.

Embodiments of the invention having two or more types exchange resin in one or more porous membranes can provide an essentially flux independent removal of charged impurities captured by the resin at flow rates of from about 1 to about 10 gallons per minute for a specified or fixed area and pressure drop for each of the resin containing porous membranes. Packed beds have lower surface area, are susceptible to channeling and fluidization of the beds. This can result in poor kinetic performance for impurity removal and lower utilization of the available capacity compared to the present invention which utilizes two or more types of exchange resin in one or more porous membranes. In embodiments of the present invention, the resin particles can be porous in nature with particle sizes which can be less than 75 microns and can have a median size about 40 to about 55 microns. These resin particles can be impregnated into a microporous structure by a casting process or other suitable process. Unlike surface functionalized membranes that have exchange groups primarily on their surface, the resin containing porous membranes of the present invention provide two or more resins throughout the porous membranes resulting in a large fluid contact surface area, faster kinetics at increased flow rates, low pressure drop, and better utilization of resin capacity. Resins having anion exchange groups as well as resins having cation exchange groups can be used to form the porous membranes.

Advantageously, embodiments of the invention can provide for less pressure drop and greater removal of charged materials from fluids above room temperatures compared to surface modified membranes. Additionally, the capacity and strength of the present resin containing porous membranes at temperatures above room temperature can be greater than other membranes that have been surface functionalized.

These and other features, aspects, and advantages of the present invention will become better understood with regard to the following description, appended claims, and accompanying drawings.

### BRIEF DESCRIPTION OF THE DRAWINGS

FIG. 1 shows the theoretically calculated removal of impurities from the feed fluid in a recirculation bath and data on the removal of ionic impurities from recirculated water at 80° C. through a surface functionalized cation membrane or for: (A) removal of Al, and (B) removal of Fe from 80° C. water.

FIG. 2 shows the theoretically calculated removal of impurities from the feed fluid in a recirculation bath and data on the removal of ionic impurities from recirculated water at 80° C. using an embodiment of the present invention having layers of exchange resin in one or more porous membranes for: (A) Al removal from the water, and (B) Fe removal from the water.

FIG. 3 shows data on the removal of material from the feed fluid at 80° C. inlet to two or more resin filled porous membranes (cation exchange and anion exchange) and a microporous flow distribution membrane (0.45 micron) for: (A) Fe and Al, and (B) Ca and Cu.

FIG. 4A shows data for the removal of ionic impurities from a 1:1:12 SC1 bath at room temperature using layers of exchange resin (cation/anion) in one or more porous membranes.

FIG. 4B shows the stability of the ion exchange capacity of a cation membrane of the present invention compared to a surface modified membrane in hot water, similar ion exchange stability would be expected for membranes containing anion or a mixture of anion and cationic exchange resins (or other mixtures of resins).

FIG. 4C illustrates the essentially flux independent removal of an impurity from a fluid stream by a membrane containing cation exchange resin (essentially flux independent removal of an impurity from a fluid for other charged or ionic impurities would be expected for membranes containing anion or a mixture of anion and cationic exchange resins (or other mixtures of resins)) compare to a surface modified membrane (squares) that shows a flux dependent removal. Resin containing membranes showing less variation in impurity removal with flux compare to the surface modified membrane over a similar range of flows for the specified membrane area may be referred to as exhibiting essentially flux independent impurity removal.

The results of FIG. 4C are scaled based on 47 mm disc of the resin containing membrane (diamonds) compared to a surface functionalized membrane (squares). Embodiments of the invention that include a porous membrane with two or more exchange resins that remove differently charged impurities may have the membrane sized to provide essentially flux independent impurity removal from a liquid with an acceptable pressure drop for a given application.

FIG. 5 is a schematic diagram of an embodiment of the invention illustrating two separate resin containing porous membranes. In some embodiments the inner resin containing porous membrane can comprise one or more exchange resins with cation exchange groups while the outer resin containing porous membrane can comprise one or more exchange resins with anion exchange groups.

FIG. 6 illustrates various non-limiting embodiments of two or more exchange resins in one or more porous membranes. (A) two different ion exchange resins in two porous membranes separated by an optional gap, the resin in each porous membrane can be considered as a layer; (B) two different ion exchange resins in two porous membranes where the membranes contact each other (physical contact, lamination, bonding), the resin in each porous membrane can be considered as a layer; (C) two different layers of ion exchange resins in a porous membrane, the resin layers can be optionally separated by a region of porous membrane; (D) illustrates one or more types of exchange resin, for example a mixture of exchange resin A and resin B, that remove different charged impurities incorporated into one or more porous membranes.

FIG. 7 illustrates an embodiment of the invention where porous membranes containing different exchange resins are in fluid communication with one another fluid containing charged impurities, that are removed by the membranes.

FIG. 8 is a graph showing the effect of resin particle size in the membrane on sodium retention performance in the presence of competing copper ions. The graph also compares the efficiency of dual layers to single layer of 10 micron particle filled membrane on sodium retention.

FIG. 9 is a graph showing sodium retention performance, in the presence of a competing ion such as copper upon sodium loading between 10 micron, 40 micron and surface modified membranes.

### DETAILED DESCRIPTION OF THE INVENTION

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit their scope which will be limited only by the appended claims.

It must also be noted that as used herein and in the appended claims, the singular forms “a”, “an”, and “the” include plural reference unless the context clearly dictates otherwise. Thus, for example, reference to a “cell” is a reference to one or more cells and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described. All publications mentioned herein are incorporated by reference. Nothing herein is to be construed as an admission that the present disclosure is not entitled to antedate these references.

“Optional” or “optionally” means that the subsequently described event or circumstance may or may not occur, and that the description includes instances where the event occurs and instances where it does not.

Several metal ions, for example Fe and Al, can exist as oxides in water and these oxides are more predominant in hot water due to increased hydrolysis. These kinds of ions can form amphoteric colloidal particles or complexes. These types of ions are often present as suspended particulate oxides and colloids which can also be charged. In basic conditions, such as base cleaning solution (SC1), some of the metal ions can exits as hydroxides, oxides, oxyhydroxides, and other anions, or any combination of these. In some fluids, metal ions may form species that are amphoteric and can include one or more of these groups and these can exist as either cationic or anionic complexes depending upon the conditions (pH, temperature, ionic strength) of the fluid. Organic molecules such as amino acids and polypeptides can also have amphoteric properties and can exist as charged impurities in a variety of liquids. Anions that may be present in fluids may include chloride, nitrate, sulfate, formate, acetate, and other inorganic as well as organic anionic species.

Embodiments of the present invention that include two or more exchange resins in one or more porous membranes may be used to remove these and other types of charged impurities from a fluid.

Ionic impurities in a variety of fluids may be detected using ion chromatography for example by the methods (and variations of these methods) disclosed by Wu et al., MICRO Magazine, October 1997, pp. 65 the contents of which are incorporated herein by reference in their entirety. The removal of material from a fluid treated by the two or more exchange resins in the porous membranes can be also determined using ICPMS.

The two or more exchange resins in one or more porous membranes can provide a treated fluid containing less ionic impurities than the fluid containing the impurities that was initially fed into the membranes. In some embodiments the impurities are removed at a temperature of about 80° C. or less. The two or more exchange resins in one or more porous membranes can provide a fluid containing less than about 1000 ppb of ionic impurities at a temperature of about 80° C. or less. In some embodiments the two or more exchange resins in one or more porous membranes can provide a fluid containing less than about 100 ppb of ionic impurities at a temperature of about 80° C. or less. In other embodiments the different exchange resins in one or more porous membranes can provide a fluid containing less than about 10 ppb of ionic impurities at a temperature of about 80° C. or less. In other embodiments the different exchange resins in one or more porous membranes can provide a fluid containing less than about 3 ppb of ionic impurities at a temperature of about 80° C. or less. The size or area of the membrane may be modified to produce the required impurity concentration and pressure drop for the application.

In various embodiments the passage of liquid through the porous membrane that includes two or more exchange resins is not limited to any particular flow rate provided an essentially flux independent charged impurity removal is achieved and a useful pressure drop for the application is provided. The area of the porous membrane used in one or more layers can be chosen to provide a device with an acceptable pressure drop and essentially flux independent retention kinetics for the flow rate and process requirements of the application. In various embodiments, the membrane area can be from about 0.25 cm² or more and the specified or fixed area used to determine pressure drop for each membrane to meet the requirements of the application.

A tight particle removal filter membrane, for example a 0.05 micron microporous filter, and porous membrane containing a cation exchange resin can be used to remove some impurities from a fluid, however it results in a differential pressure drop of about 8-10 psi or greater at fluid flows of about 3 to about 4 gallons per minute (about 10,000 to about 15,000 cc/min). In contrast, an article that includes a porous membrane containing anion exchange resin and a porous membrane containing cation exchange resin can be used to remove an equal or greater amount of charged impurities from the same fluid with a smaller differential pressure loss, for example about 3 psi or lower, at a flow rate of from about 3 to about 4 gallons per minute.

One embodiment of the invention provides an apparatus and a method for treating a fluid containing anionic, cationic and suspended particulates. The apparatus can include two or more ion exchange resins, the ion exchange resin incorporated in one or more porous membranes, each resin having an affinity for different charged contaminants. The fluid may be treated by flowing it through the two or more porous resin materials incorporated into one or more porous membranes. The resin and porous membrane removes charged contaminants and optionally neutral particles from the fluid. The method is applicable for liquid dispense, point of use liquid dispense, re-circulation baths, fluid spray guns such as for IPA or other solvents and liquids, as well as flow through purification processes.

The adsorbents or resin (ion exchange, chelation, or other complexing agent) used in embodiments of this invention can be precipitated, ground, or otherwise suitably milled anion and cation exchange resins, chelating resins or adsorbant resins to provide resin substrates with a particle size in the range of about 5 to about 600 microns. In some embodiments the ground resin particle size can range from about 8 to about 75 microns. In some embodiments the ground resin particle size can range from about 8 to about 75 microns with a median size of about 40 microns. In some embodiments the particles can be in the range of from about 8 to about 20 microns, the smaller particles provide improved (retention, capacity, and kinetics) and also permit the pores of the porous membrane material to be made smaller. The distribution of particle sizes can vary; however, in some embodiments it can be less than about ±25%, in other embodiments it can be less than about ±10%.

The two or more exchange resins incorporated into the one or more porous membrane can have a loading that provides useful capacity and a stable membrane for its intended use (integral membrane, chemically resistant, does not release captured impurities). In some embodiments the resin loading in the cast porous membrane can be from about 50 to about 90% by weight, in some embodiments the resin loading can be from about 80 to about 90% by weight for higher exchange capacity, and other embodiments the resin loading can be from about 50 to about 80% by weight for greater membrane porosity. Although the two or more types of exchange resin incorporated into one or more porous membranes can be used in a variety of chemically compatible fluids, the capacity of the resin containing membrane can be characterized as having an total ion exchange capacity of greater than about 2.5 meq/gram, in some embodiments, and in other embodiments a total ion exchange capacity of greater than about 3.5 meq/gram at a temperature of about 23° C. and a pH of about 6-7.

Polymers that can be used to form the porous membrane with the exchange resin incorporated into the membrane can include any polymeric material that can be processed into a porous membrane. Examples of polymeric materials that can be used for membranes include but are not limited to polypropylene, polyethylene, PTFE, UPE, PVDF, polytetrafluoroethylene, PFA, FEP, PES, Nylon, blends of any of these polymers, and other polymers that can be processed into membranes, preferably those that can be cast, preferably melt cast, into porous membranes or microporous membranes.

The exchange resin containing membrane can have a thickness of about 50 microns to about 520 microns. In some embodiments where lower capacity or lower pressure drop are desired, the resin containing porous membranes can have a thickness of from about 200 to 300 microns.

The pores of the cast porous membrane are not limited to any particular range provided fluid can flow through the membrane and contact the resin. However, smaller pores can provide better particle retention and improved kinetics of retention for impurities by the resin in the membrane. In some embodiments the pores of the membrane can retain particles of less than 2 microns by sieving filtration. In other embodiments, the particles retained by the resin containing membrane can be less than 0.5 microns. In some embodiments the layers of exchange resin is in one or more microporous membranes.

The layers of exchange resin in one or more porous membranes may be used to remove charged materials from chemically compatible fluids. The charged materials can be dissolved ions (for example cations and anions including but not limited to calcium, iron, aluminum, sodium, copper, chloride, acetate, formate, or others), or suspend charged particles, ions, charged colloids, charged polymers, charged oligomers, or other charged aggregates. These fluids can include water, acids, bases, buffers, oxidizers and other chemicals like surfactants, organic solvents, or any combination of these. Fluids can include organic solvents that can dissolve or suspend charged particles. Examples of fluids can include hot DI water for cleaning or mixing with other chemicals, for example SC1 (1:1:12); or SC1 (1:1:30) for very narrow line width semiconductor processes. Other fluids may include but are not limited to TMEHA (choline), TMAH, NH₄OH, NH₄F and the like. Fluids such as developer, photoresist, top and bottom antireflective coatings, solvents, buffers, spin on dielectrics, monomers dissolved in a solvent, or other fluids may be treated with the two or more exchange resins in one or more porous membranes to remove charged materials from the fluids. Fluids used to make pharmaceutical compositions may also be treated with embodiments of the invention to remove endotoxins, proteins and other charged materials from the fluids.

The temperature of the fluid that contacts the two or more types of exchange resin in one or more porous membranes is a temperature where the membrane and resin remain integral, porous, and the resin binding is sufficient for removing and retaining impurities for a given application. The temperature is one where the membrane has essentially flux independent removal for differently charged impurities. In some embodiments the temperature of the fluid may be about 100° C. or lower. In other embodiments temperature of the fluid can be about 80° C. or less, and preferably the temperature of the fluid can range from about 20° C. to about 45° C. Temperatures below room temperature can also be used, for example dilute solutions of ozone (or inert gases) dissolved in water at temperatures less than about 20° C. can be treated with such resin containing porous membranes to remove impurities from the water.

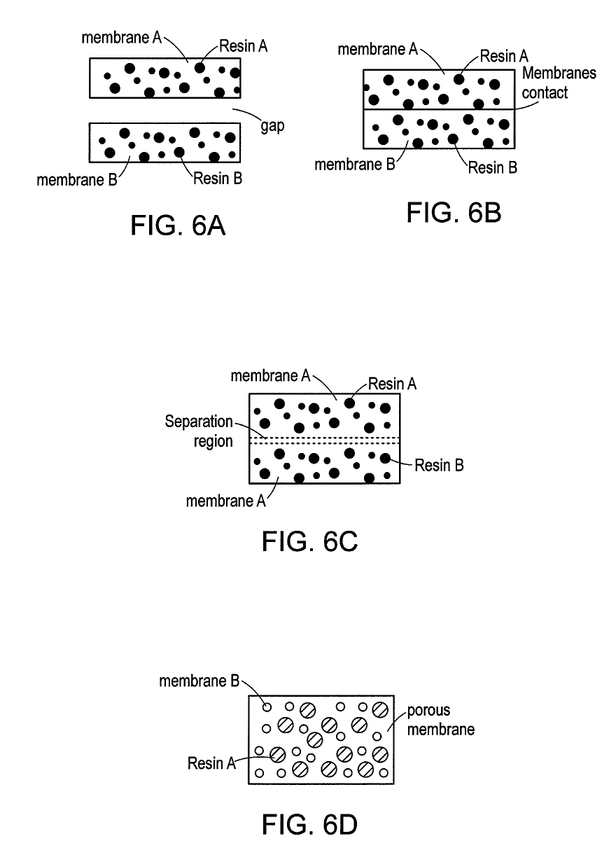

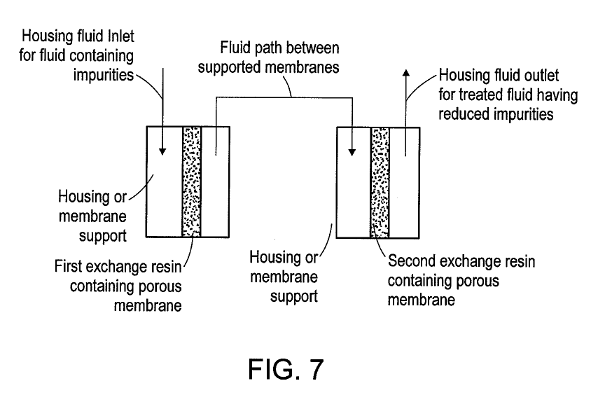

In embodiments where exchange resin for removing a like charged impurities is in different layers, as illustrated in FIG. 6. (A-C), the order of the layers of different resin separated by a porous membrane, or the order of layers of porous membrane containing different resins is not limited by whether the anion exchange material contacts the liquid first or whether the cation exchange resin contacts the liquid first. In some embodiments the resin layer in the porous membrane that includes the cation exchange material contacts the fluid first. Also, although the amount of the two or more exchange resins incorporated into the cast membranes can be the same by weight or by capacity of resin, other ratios less than 100 and greater than 0 percent are possible. For example, a porous membrane with about 40% of a first cation exchange resin and 40% of a second cation exchange by weight in a first membrane can be used with a downstream porous membrane with about 25% of first type of anion exchange resin and 15% of a second type of anion exchange resin in a second porous membrane by weight may be used.

A structure that improves the residence time of the fluid in contact with the resin containing porous membranes can be provided. This structure can be referred to as a flow distributor and can include baffles, a valve, or an optional third layer of porous membrane that can be positioned following the resin filled porous membranes, or other structures to modify the liquid flow. The third layer of membrane may further include a resin in the porous membrane to remove other impurities from the fluid such as trace organics or other impurities. The structure for distributing the flow of fluid can be fixtured to the housing.

The resin or other particulate material incorporated into the porous membrane for removing charged material from a fluid preferably has a high surface area and can be a solid, porous, layered, or any combination of these. Throughout the specification and claims the term resin will refer to any material incorporated into the porous or microporous membrane whether the material incorporated is organic, a polymer, inorganic (clays, zeolites), a ceramic, silica, a modified or functionalized silica or other similar material. For porous resins or other material, preferably the pores are comparable to or larger than the pores of the membrane. In some embodiments the pores of the resin are about 50 to 150 microns. Prior to incorporation into the porous membrane, the resin may be treated to remove any harmful ions or other materials bound to the resin. For example, for cation exchange resins, any metals bound to the acid groups may be removed by treatment of the resin with high purity hydrochloric acid and washing with deionized water having a resistivity of about 18.2 Mohms or higher. Alternatively, the membranes containing the resin may be regenerated for example with an acid and suitable flushing.

The resin or a mixture of exchange resins can be suspended in the porous membrane material or bonded by one or more functional groups on the resin to the porous membrane material.

A process and examples of making microporous ion exchange particle filled UPE membranes is described in U.S. Pat. No. 5,531,899 which is incorporated in its entirety into this application by reference. In some embodiments the exchange resin in one or more porous membranes may comprise one or more cation exchange resins that includes anionic groups bound to the resin that release cations, like hydrogen ions, into the fluid to be purified. Cationic exchange resins can include sulfonic, phosphonic, carboxylic and other acid groups as well as mixtures including these groups. Examples of one or more types of cation exchange resins suitable for purposes of this invention can include but are not limited to C-100 H, from Purolite, DUOLITE® C-433 and C-464 resins from Dowex, AMBERLITE® resins such as IRP-64, IRP-88, IRC-50, IRC-50S, and C-464 ion exchange resins from Rohm and Haas Company. The resins can have cross linking of less than about 20%, and preferably from about 2% to about 16% for improved thermal stability and better selectivity than resins that are more highly cross linked.

The exchange resin in one or more porous membranes can comprise one or more anion exchange resins which can include but is not limited to those primary, secondary, tertiary amine based resins, or other cationically charged material, having a counter ion, preferably including a hydroxide counter ion, where the hydroxide is introduced into the fluid during the exchange process. Anion exchange resins can have structurally bound quaternary ammonium hydroxide exchange groups such as polystyrene-divinyl benzene resins substituted with tetramethyl ammonium hydroxide. An example of one or more types of an anion exchange resin that can be used in embodiment of the invention is crosslinked polystyrene having quaternary ammonium hydroxide substitution such as those ion exchange resins sold under the trade names AMBERLYST®, A-26-OH by Rohm and Haas Company, DOW G51-OH by Dow Chemical Company, and or the resin A430 OH by Purolite.

The exchange resin in one or more porous membranes may comprise a chelating ion exchange resin, such as a styrene/divinylbenzene chelating ion exchange resin. The chelating exchange resin can also be can be combined with other cation or anion exchange materials. A chelating ion exchange resin can be one that has paired iminodiacetate functional groups or iminodiacetic acid functional groups. Other resins that can be incorporated into the porous membrane may include Diphonex® resin containing diphosphonate exchange groups from Eichrom or phosphonate or phosphoric acid groups such as those found in the resin S 940 from Purolite. Diphonex® as well as other chelating resins may be combined with other resins like cationic resins.

One embodiment of the invention is a process for the purification of a liquid. The process can include the acts of contacting the liquid with a cation exchange resin incorporated into a first layer of porous membrane and then contacting the liquid with an anion exchange resin incorporated into a second layer of porous membrane. The cation exchange resin can have acidic groups while the anion exchange resin can have hydroxide exchange groups. The combination of exchange resins yields counter-ions that can form water or another benign compound in the liquid treated by the exchange resin containing porous membranes.

The various exchange resins can be incorporated into non-fibrous, cast, microporous membranes by mixing one or more exchange resins with a polymer and casting or extruding the mixture into the desired form of the membrane. Membranes may be formed as flat sheets or as hollow fibers. The powdered adsorbents or exchange resins can be impregnated into the membrane base and the membrane produced by a casting process, for example air casting, melt casting, or immersion casting or other suitable membrane forming process that results in a porous membrane having a sponge like structure, preferable a microporous membrane. The porous membrane can include two or more types of exchange resin, for example, a mixture of different cation exchange resins or a mixture of anion and cation exchange resins. The porous membrane may include one or more layers of exchange resin. Processing conditions can be chosen to form porous membranes capable of providing high flow and low pressure drop. Exchange resin loading in the porous membrane can be modified to provide high ion exchange capacity membranes.

Preferably the membrane is wet by the fluid without the need for pre-wetting. Where the membrane is not wet, suitable solvents, surfactants, a static soak, or pressure intrusion may be used to wet the membrane prior to use.

Embodiments of the present invention can be used to remove charged material from a fluid. The charged material can have different sign and charge, however the total charge for the fluid will be balanced. Ions (anions and cations), charged nanoparticles, charged colloids, charged proteins or polypeptides, charged oligomers, charged polymers, charged clusters, or other charged aggregates may be removed by the layers of exchange resin in one or more porous membranes in embodiments of the invention.

The exchange resin particle containing membrane can be fabricated in a device. This can include single or multiple layers of pleated resin containing membrane, stacked disc device, tangential flow, or hollow fiber configuration. A third layer containing an open microporous membrane, for example but not limited to 0.45 microns, can be included to provide a uniform flow distribution for improved kinetic performance.

The following examples will serve to illustrate various embodiments of the present invention, but should not be construed as a limitation in the scope thereof. One skilled in the art will appreciate that although specific reagents and conditions are outlined in the following examples, modifications can be made which are meant to be encompassed by the spirit and scope of the invention.

### EXAMPLE 1

This example illustrates the removal performance of a surface functionalized membrane or a single cation resin containing membrane in hot water.

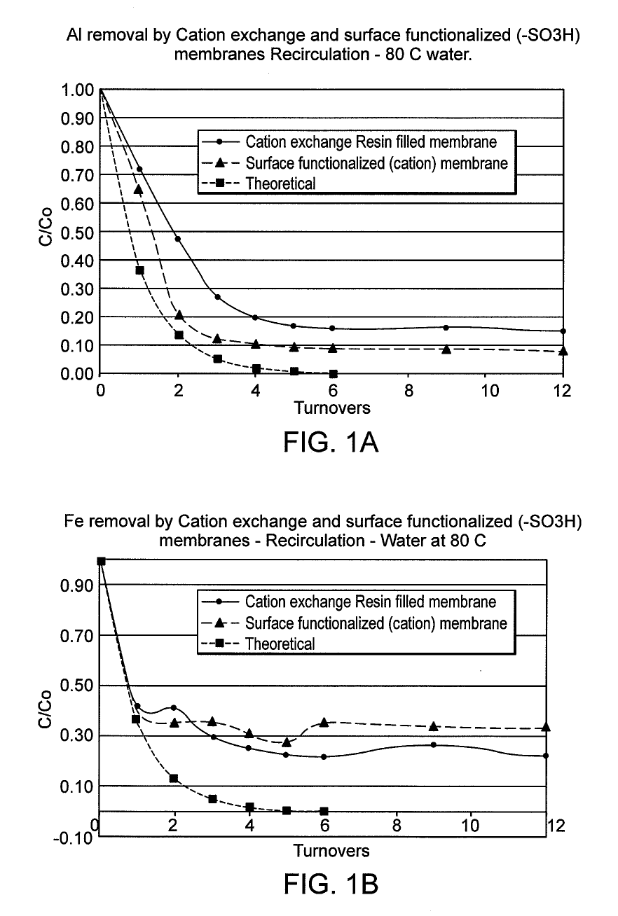

FIG. 1 illustrates the rate of removal of Al metal ions (A) and Fe metal ions (B) in a re-circulation bath containing water at 80° C. and spiked with known concentration of selected metal ions. These data are for surface functionalized sulfonic acid modified PE substrate or cation resin filled polyethylene membrane. Both showed limited removal of Fe and Al ions compared to the theoretical curve, suggesting presence of non-removable species such as suspended oxides of Al or Fe.

### EXAMPLE 2

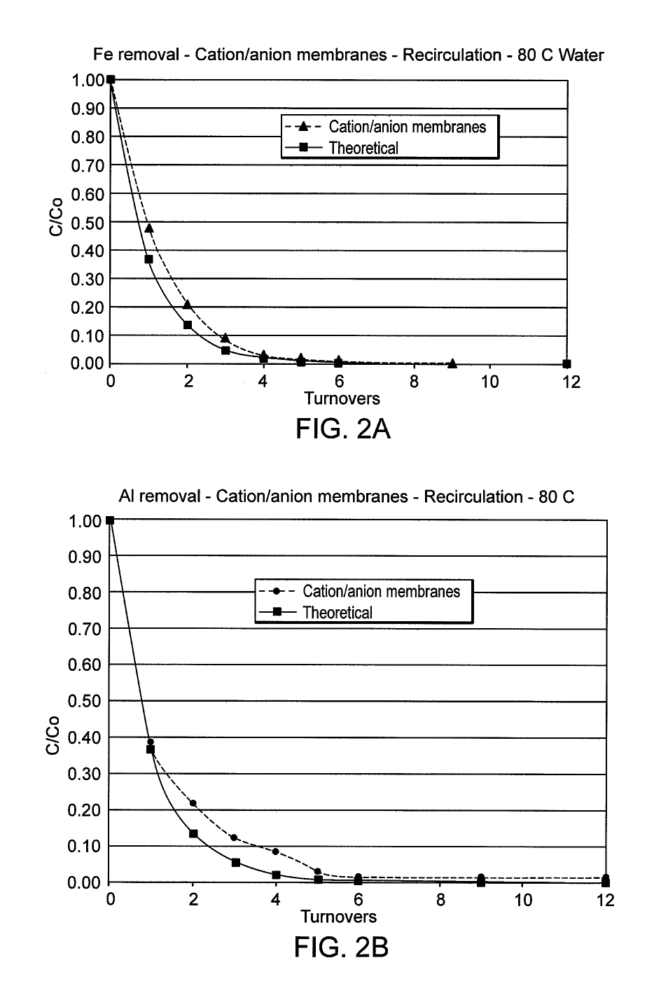

In another experiment, a two-layer configuration containing a cation resin filled UPE membrane of current invention followed by an anion resin filled microporous membrane of current invention was evaluated under the same conditions as in Example 1. The rate and amount of removal of Fe FIG. 2(A) and Al FIG. 2(B) ions are improved, especially after about 4 turnovers, compared to the results of Example 1. Quantitative removal (detection limit) of these ions at nearly the theoretical rate in 80° C. water was observed suggesting the combination of both layers remove the material from the water.

### EXAMPLE 3

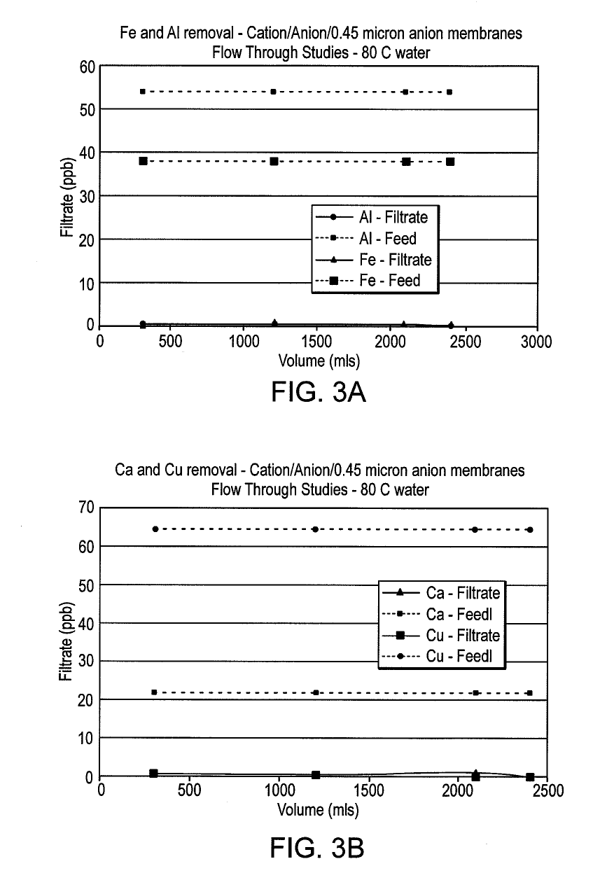

In the third experiment, three layers of 47 mm disks membrane were configured as follows: a cation exchange resin filled UPE membrane layer, an anion exchange resin filled membrane layer of current invention, a microporous (cationic) 0.45 micron UPE membrane layer. (Alternatively a 0.05 micron sieving filter could be used.) This configuration of membranes was evaluated at a fluid flow of about 20 ml/min of 80° C. water. A flow through experiment was conducted and the results are shown in FIG. 3(A) and FIG. 3(B). These results could be scaled to a flow of about 3 to about 4 gallons per minute (about 15,200 cm³ min⁻¹) through approximately 10,000 cm² area for each membrane to provide a similar pressure drop and removal to less than about 10 ppb (v/v), of impurity. The results are shown in FIG. 3(A) for Al and Fe, and in FIG. 3(B) for Ca and Cu. The results indicated removal of metal ions in hot water.

### EXAMPLE 4

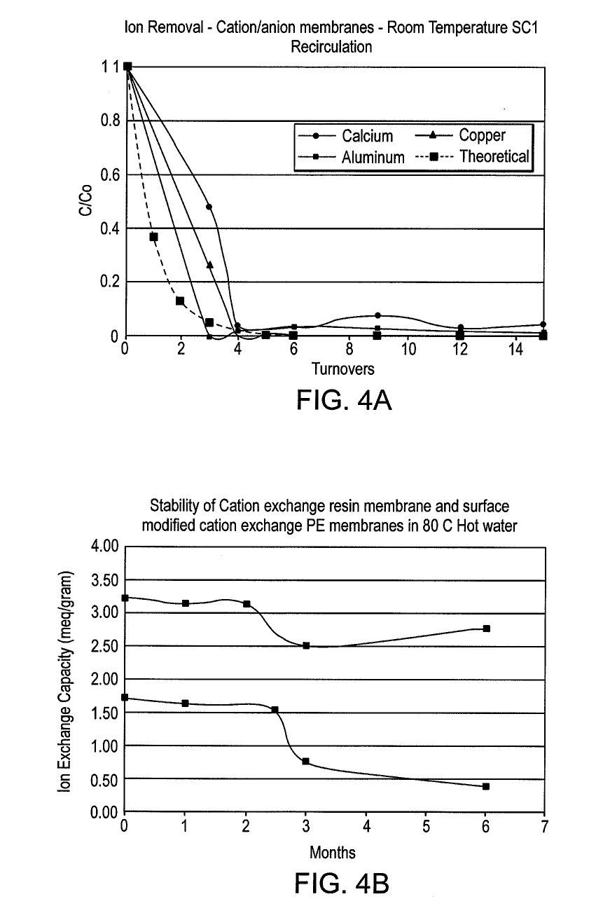

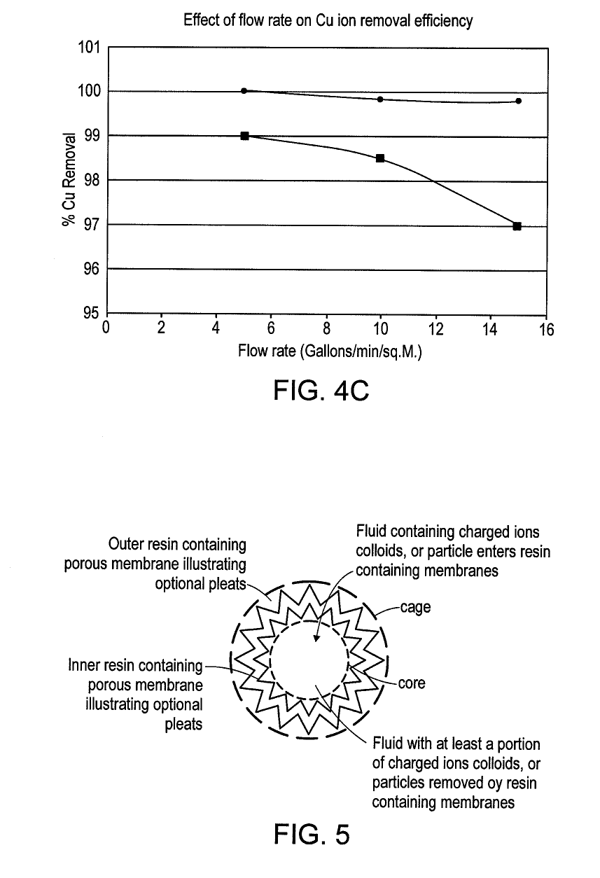

Rate of removal of metal ions in wet etch base cleaning solution (SC1) containing 1 part of 30% hydrogen peroxide, 1 part of 30% ammonium hydroxide and 12 parts of water, referred to as (1:1:12) SC1, and spiked with selected metal ions was evaluated. (The amount of water in various SC1 mixtures used in semiconductor processing can range from 1 to about 30 parts; the amount of 30% ammonium hydroxide can range from about 1 to about 5 parts). The absorbent medium was three layers consisting of cation/anion/0.45 micron microporous membrane of current invention and results are shown in FIG. 4. The results indicate that Ca, Cu, and Al materials can be removed from such a fluid.

### EXAMPLE 5

In this example, a feed containing 123 ppb of copper ions (competing ion) and 214 ppb of sodium ions in water was passed through a 47 mm disc membrane at a flow rate of 40 mls per minute. The membranes made with 40 micron and 10 micron particles are used for this evaluation.

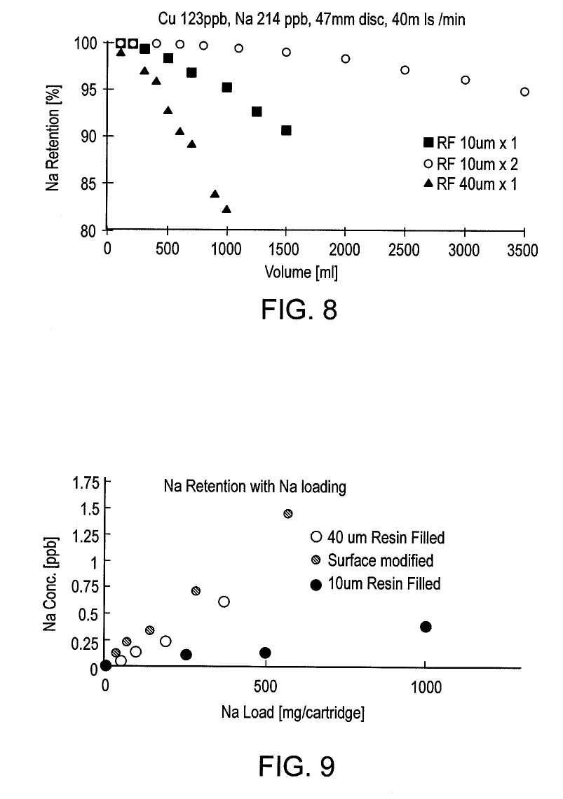

The graph shown in FIG. 8 is an example of the effect of resin particle size (40 micron (triangle) vs. 10 micron) in the membrane on sodium retention performance in the presence of competing copper ions. The graph also compares the efficiency of dual layers (ovals) to single layer (square) of 10 micron particle filled membrane on sodium retention.

### Conclusion

Sodium retention performance of 10 micron resin particle filled membrane is better than 40 micron resin particle filled membrane. These data support the claim that increased surface area of the particles improves absorption kinetic performance of ions.

### EXAMPLE 6

In this example, a feed containing 123 ppb of copper ions and 214 ppb of sodium ions in water was passed through membrane at 40 mls per minute. The results are normalized to a single 10″ catridge.

The graph shown in FIG. 9 is a comparitive example of sodium retention performance, in the presence of a competing ion such as copper, upon sodium loading between 10 micron (solid circle), 40 micron (open circle), and surface modified membranes (broken/grey circle).

### Conclusion

In this example the data compares three different membrane substrates including the surface modified membranes. The Na retention of the surface modified membrane is worse than the 40 micron particle membrane.

Although the present invention has been described in considerable detail with reference to certain preferred embodiments thereof, other versions are possible. Therefore the spirit and scope of the appended claims should not be limited to the description and the preferred versions contain within this specification.

What is claimed is:

1 An article comprising:
two or more exchange resins, the exchange resins in one or more porous membranes, the exchange resins remove material of different signed charge from a fluid that contacts the porous membranes.

2. The article of claim 1 where two or more exchange resins are in separate layers.

3. The article of claim 1 where the two or more two or more exchange resins are in separate porous membranes.

4. The article of claim 1 where the material of different signed charge comprises charged ions, charged colloids, charged particles, or combinations including these in the fluid that contact with the porous membranes.

5. The article of claim 1 where the membrane further removes particles from the fluid by sieving filtration.

6. The article of claim 1 wherein the membranes are characterized by providing a treated fluid containing a lower concentration of ionic impurities at a temperature of 80° C. or less than a feed fluid.

7. The article of claim 1 where the membrane is a cast membrane.

8. The article of claim 1 further including a flow distributor that is a microporous membrane.

9. The article of claim 1 further comprising a housing, the membranes fixtured to the housing, the housing has an inlet that provides a fluid to the membranes and an outlet for removing fluid from the housing treated by the membranes.

10. An apparatus for treating substrates comprising the article of claim 1.

11. A substrate treated by the apparatus of claim 10.

12. A process fluid treated by the article of claim 1 having less than 1000 ppb (v/v) of ionically charged impurity.

13. The process fluid of claim 12 wherein the ionic impurity comprises iron, aluminum, calcium, copper, or any combination of these.

14. The article of claim 1 having a third porous membrane.

15. A method for purifying a fluid comprising:
flowing the fluid through one or more porous membranes, the membranes comprising two or more exchange resins that removes material of different sign from the fluid.

16. The method of claim 15 where the resin in the porous membranes is a porous ion exchange resin.

17. The method of claim 15 further comprising flowing the fluid through a third porous membrane.

18. An article comprising two or more porous membranes, each porous membrane comprising one or more types of porous resin particles that remove charged impurities of different signed charge.

19. An article comprising:
one or more porous membranes, the membrane comprising a resin that removes material of different sign from a fluid in contact with the membranes.

20. The article of claim 19 where the material of different sign comprises charged ions, charged colloids, charged particles, or combinations including these in the fluid in contact with the membranes.

21. The article of claim 19 where the membrane further removes particles from the fluid by sieving filtration.

22. The article of claim 19 wherein the membranes are characterized by providing a fluid containing less than 1000 ppb of charged impurities at a temperature of 80° C. or less.

23. The article of claim 19 where the porous membrane is a cast membrane.
